(19) United States
(12) Patent Application Publication
(10) Pub. No.: US 2012/0299336 A1
(43) Pub. Date: Nov. 29, 2012

(54) Wind deflector for a vehicle

(75) Inventor: Paul Lin, Tainan City (TW)

(73) Assignee: MACAUTO INDUSTRIAL CO., LTD.

(21) Appl. No.: 13/136,737

(22) Filed: Aug. 9, 2011

(30) Foreign Application Priority Data
May 25, 2011 (TW) 100209372

(51) Int. Cl. B60J 7/22

(52) U.S. Cl. 296/217

(57) ABSTRACT

A wind deflector mountable on a roof of a vehicle in front of a roof opening, includes an elongated web structure having two end portions which are longitudinally opposite to each other, and at least one lateral reinforcing unit bonded to at least one of the end portions, and having at least one lateral reinforcement strip that extends longitudinally of the web structure, that is welded to one of the end portions, and that has a lateral welded face fixed to the web structure.

### CROSS-REFERENCE TO RELATED APPLICATION

This application claims priority of Taiwanese Patent Application No. 100209372 filed on May 25, 2011.

### BACKGROUND OF THE INVENTION

1. Field of the Invention

The invention relates to a wind deflector, and more particularly, to a wind deflector mountable on a roof of a vehicle.

2. Description of the Related Art

Referring to FIGS. 1 and 2, a conventional wind deflector 1 is installed through a support frame 11 on a roof of a vehicle near a roof opening 12. The wind deflector 1 includes an elongated wind shield 13 made of a fabric material, and two rubber strips 14 sewn to the wind shield 13. Two portions of the wind shield 13, which are longitudinally opposite to each other, are curved along the support frame 11 to form two curved lateral end portions 131. The rubber strips 14 extend longitudinally of the wind shield 13 and are fixed respectively to the lateral end portions 131 by sewing.

Generally, when the roof opening 12 is opened, air drafts and noises are produced during rapid motion of the vehicle which disturb passengers inside the vehicle. The wind deflector 1 is designed to deflect the air drafts sideward, reduce the noises and prevent intrusion of the drafts into the vehicle. Because the wind deflector 1 must endure a relatively large pressure at the two lateral end portions 131, the rubber strips 14 are provided for the purposes of strengthening the lateral end portions 131.

However, the rubber strips 14 sewn to the lateral end portions 131 can result in protruding surfaces on the wind shield 13, and the sewing stitches on the wind shield 13 are susceptible to breakage, which will render the rubber strips 14 unable to couple with the wind shield 13. Especially, because only a stitch line 15 is used to sew a middle part of each rubber strip 14 to the wind shield 13, the rubber strip 14 cannot be fixed tightly to the wind shield 13. Thus, clearances are likely to form between the rubber strips 14 and the wind shield 13 due to air drafts. Although the rubber strips 14 may be glued to the wind shield 13 before sewn to the wind shield 13, application of the glue can affect adversely the appearance of the wind deflector 1. In addition, because the glue is liable to lose its adhesion due to weather, the use of the glue will not necessarily help the rubber strips 14 couple firmly to the wind shield 13.

### SUMMARY OF THE INVENTION

An object of the present invention is to provide a wind deflector with a robust web structure while still maintaining a good appearance for the web structure.

According to the present invention, a wind deflector mountable on a roof of a vehicle in front of a roof opening, comprises: an elongated web structure having two end portions which are longitudinally opposite to each other; at least one lateral reinforcing unit bonded tout least one of the end portions, and having at least one lateral reinforcement strip that extends longitudinally of the web structure, that is welded to one of the end portions, and that has a lateral welded face fixed to the web structure.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view showing a conventional wind deflector mounted on a vehicle;

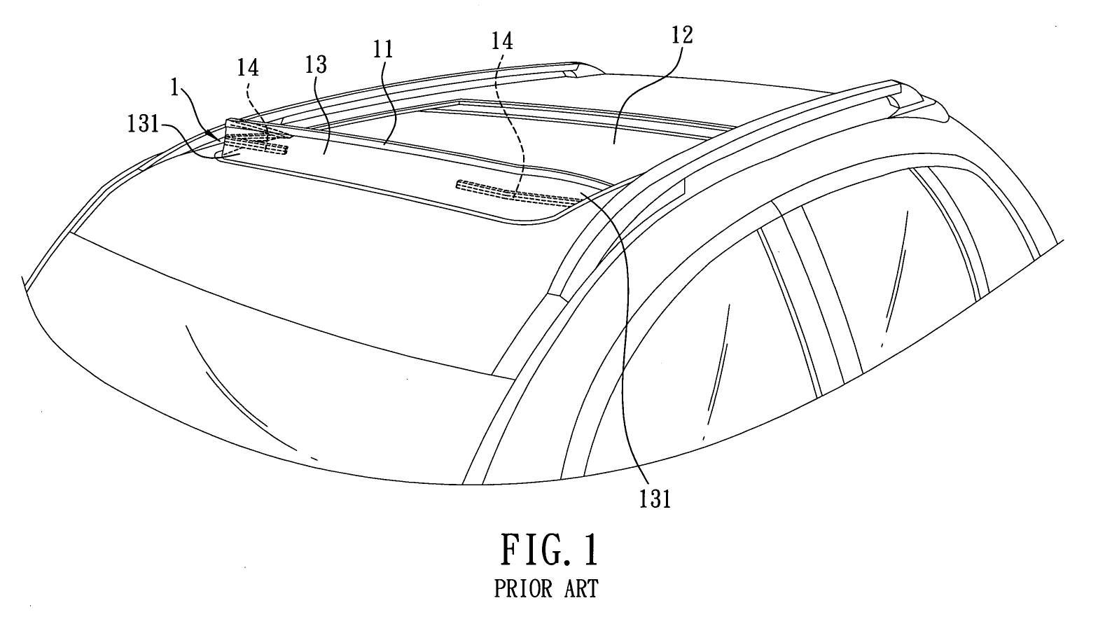

FIG. 2 is a sectional side view of the conventional wind deflector;

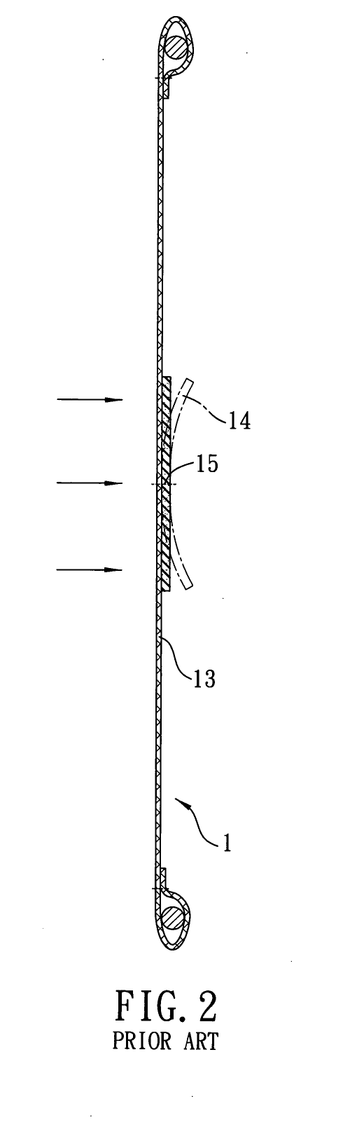

FIG. 3 is a front view of a wind deflector according to a first preferred embodiment of the present invention;

FIG. 4 is a perspective view showing the wind deflector of FIG. 3 mounted on a vehicle;

FIG. 5 is a sectional side view of the wind deflector of FIG. 3; and

FIG. 6 is a sectional side view of a wind deflector according to a second preferred embodiment of the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

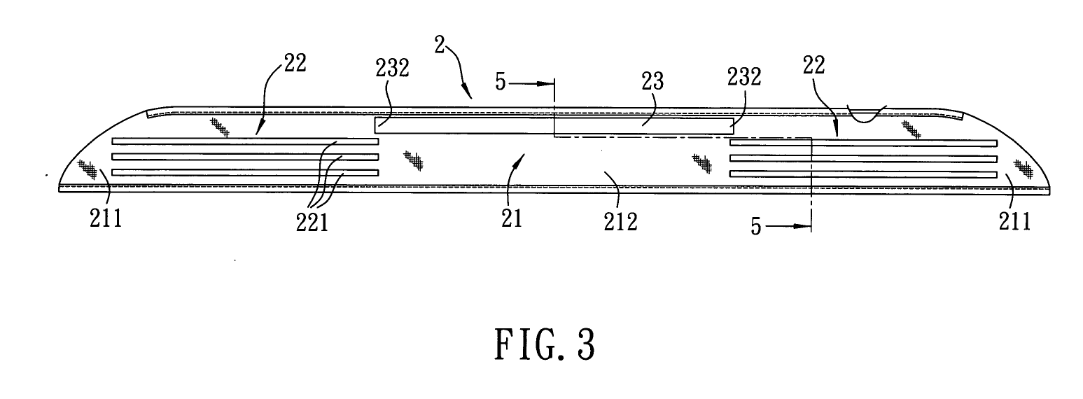

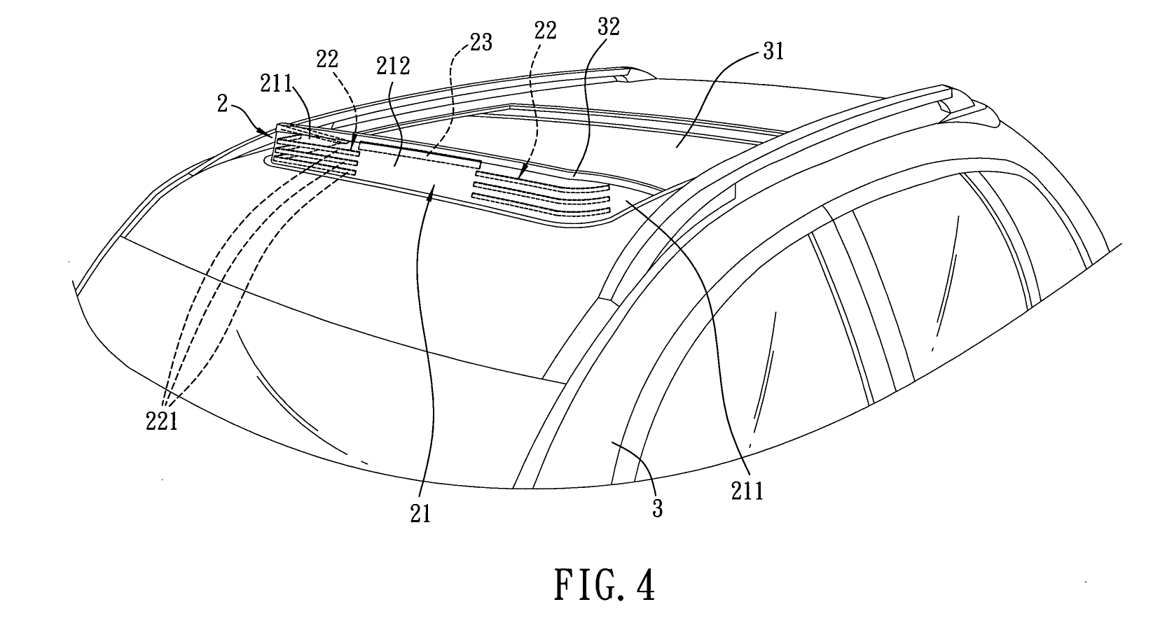

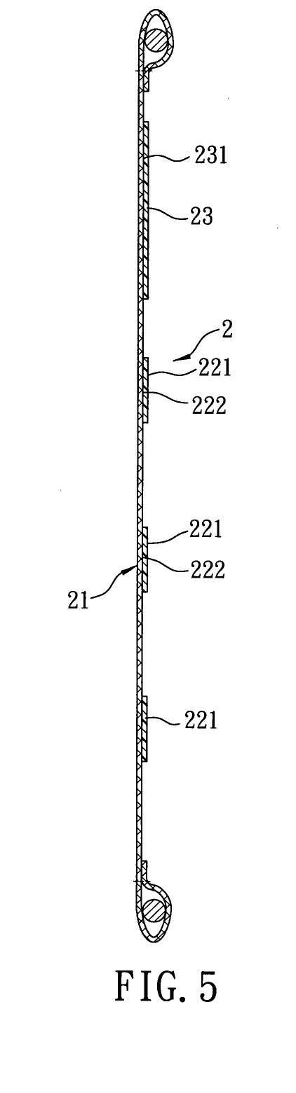

Referring to FIGS. 3, 4 and 5, a wind deflector 2 according to a first preferred embodiment of the present invention is mounted on a roof of a vehicle 3 in front of a roof opening 31. The wind deflector 2 is supported by a support frame 31 to extend upward in front of the roof opening 31.

The wind deflector 2 includes an elongated web structure 21 that has two longitudinally opposite end portions 211, and a middle portion 212, two lateral reinforcing units 22 bonded respectively to the end portions 211 of the web structure 21, and a middle reinforcement strip 23 bonded to the middle portion 212 of the web structure 21. The web structure 21 may be made of a cloth material, or a mesh material having mesh openings. The lateral end portions 211 are curved, and the middle portion 212 is situated between the lateral end portions 212.

Each lateral end portion 22 has a plurality of lateral reinforcement strips 221 that are spaced apart from each other along a top-bottom direction and that extend longitudinally of the web structure 21. The lateral reinforcement strips 221 are made from a weldable plastic material, and are bonded to the web structure 21 by welding, such as high frequency welding, ultrasonic welding, pressure welding, etc. When the lateral reinforcement strips 221 are welded to the web structure 21, the melted plastic material of the lateral reinforcement strips 221 permeates into the fibers of the web structure 21 and thus forms a firm connection with the web structure 21. Accordingly, each lateral reinforcement strip 221 has a lateral welded face 222 fixed to one side of the web structure 21.

The middle reinforcement strip 23 is also made of a weldable plastic material and is bonded to the middle portion 212 of the web structure 21 such as by high frequency welding, ultrasonic welding, pressure welding, etc. The middle reinforcement strip 23 has a middle welded face 231 fixed to the web structure 21, and two outer ends 232 extending above and in proximity to inner ends of the lateral reinforcement strips 221. The outer ends 232 of the middle reinforcement strip 23 are therefore overlapped with the inner ends of the lateral reinforcement strips 221.

The wind deflector 2 is attached to the support frame 32. When the support frame 32 is unfolded, the wind deflector 2 is in an inclined position in front of the roof opening 31. When the vehicle 2 is driven, air drafts can be guided upwards and sidewards. Because a plurality of the lateral reinforcement strips 221 are disposed at intervals on each end portion 211 of the web structure 21, the wind-bearing capacity of the web structure 21 at the two end portions 211 is increased. In addition, because the middle portion 212 of the web structure 21 has the middle reinforcement strip 23, which overlaps with the lateral reinforcement strips 221, the web structure 21 has a high wind-bearing capacity either at the lateral portion 211 or the middle portion 212.

The lateral and middle reinforcement strips 221, 23 may be welded to the web structure 21 by simply laying the lateral and middle reinforcement strips 221, 23 on the web structure 21 before heat is applied thereto for welding. After the lateral and middle reinforcement strips 221, 23 are welded, they are bonded face-to-face to the web structure 21. The aforesaid bonding procedure is convenient and can provide a firm connection. Although the lateral and middle reinforcement strips 221, 23 protrude slightly from the web structure 21, since the lateral and middle welded faces 222, 231 are entirely adhered to the web structure 21, the web structure 21 has good appearance.

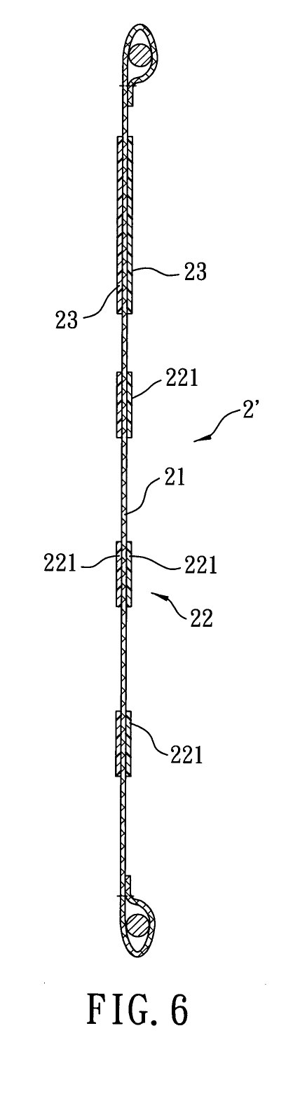

Referring to FIG. 6, the wind deflector 2′ according to the second preferred embodiment of the present invention is substantially similar to that of the first preferred embodiment. However, the wind deflector 2′ has a plurality of pairs of the lateral reinforcement strips 221, and a pair of the middle reinforcement strips 23. The pairs of the lateral reinforcement strips 221 are spaced apart along a top-bottom direction. Each pair of the lateral and middle reinforcement strips 221, 23 are bonded respectively to two opposite sides (front and rear sides) of the web structure 21. Therefore, the lateral welded faces 222 of each pair of the lateral reinforcement strips 221 face each other and are fixed respectively to the opposite sides of the web structure 21. The middle welded faces 231 of the paired middle reinforcement strips face each other and are fixed respectively to the opposite sides of the web structure 21.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A wind deflector mountable on a roof of a vehicle in front of a roof opening, comprising:
an elongated web structure having two end portions which are longitudinally opposite to each other;
at least one lateral reinforcing unit bonded to at least one of said end portions, and having at least one lateral reinforcement strip that extends longitudinally of said web structure, that is welded to said one of said end portions, and that has a lateral welded face fixed to said web structure.

2. The wind deflector of claim 1, wherein said lateral reinforcing unit has a plurality of said lateral reinforcement strips, which are spaced apart along a top-bottom direction.

3. The wind deflector of claim 1, further comprising a middle reinforcement strip, said web structure further having a middle portion between said end portions, said middle reinforcement strip being welded to said middle portion and having a middle welded face fixed to said web structure.

4. The wind deflector of claim 3, wherein said middle reinforcement strip is elongated longitudinally of said web structure.

5. The wind deflector of claim 4, wherein each of said end portions of said web structure has said lateral reinforcement strip bonded thereto, said middle reinforcement strip having two outer ends respectively overlapped with said lateral reinforcement strips on said end portions of said web structure.

6. The wind deflector of claim 1, wherein said lateral reinforcing unit has a pair of lateral reinforcement strips that are bonded respectively to two opposite sides of said web structure, said lateral welded faces of said lateral reinforcement strips facing each other and being fixed respectively to said opposite sides of said web structure.

7. The wind deflector of claim 3, wherein a pair of said middle reinforcement strips are disposed on two opposite sides of said web structure, said middle welded faces of said middle reinforcement strips facing each other and being fixed respectively to said opposite sides of said web structure.
